(19) United States
(12) Patent Application Publication
(10) Pub. No.: US 2012/0288431 A1
(43) Pub. Date: Nov. 15, 2012

(54) High-Temperature Treatment of Hydrous Minerals

(76) Inventors: Andrew V.G. Chizmeshya, Chandler, AZ (US); Geoffrey Frederick Brent, Valentine (AU)

(21) Appl. No.: 13/496,046

(22) PCT Filed: Sep. 16, 2010
(86) PCT No.: PCT/US10/49152

§ 371 Date: Jun. 11, 2012

Related U.S. Application Data
(60) Provisional application No. 61/243,587, filed on Sep. 18, 2009.

(51) Int. Cl. C01F 5/24; C01B 33/22

(52) U.S. Cl. 423/331; 423/430

(57) ABSTRACT

Increasing the activity of a hydrous magnesium silicate with respect to sequestration of carbon dioxide by mineral carbonation includes rapid heating of the hydrous magnesium silicate. Rapid heating of the hydrous magnesium silicate includes heating a quantity of particles of hydrous magnesium silicate with flame conditions to substantially dehydroxylate the particles. The dehydroxylated particles can be contacted with carbon dioxide in a sequestration process to form magnesium carbonate.

### TECHNICAL FIELD

The present invention relates to a process for sequestration of carbon dioxide gas and is particularly concerned with chemical conversion of carbon dioxide to solid carbonates, thereby reducing the accumulation of carbon dioxide in the atmosphere. In particular, the present invention relates to the production of a feedstock that has been activated with respect to sequestration of carbon dioxide by mineral carbonation. The present invention also relates to a method for the mineral carbonation, and thus sequestration, of carbon dioxide using such an activated feedstock.

### BACKGROUND

The sequestration of carbon dioxide gas in repositories that are isolated from the atmosphere is a developing technology that is recognized as an element in global attempts to reduce carbon dioxide emissions to the atmosphere. The rapid increase in atmospheric carbon dioxide concentrations is of concern due to its properties as a greenhouse gas and its contribution to the phenomena of global warming and climate change. While various technologies exist for the capture and concentration of carbon dioxide in combustion flue gases, most current facilities utilize underground sequestration known as geosequestration. This may occur in depleted oil or gas reservoirs or other underground porous formations that are suitably isolated from the atmosphere. These reservoirs or formations may be situated under land or sea. Another possible subterranean repository for carbon dioxide gas is so-called saline aquifers. Direct storage of carbon dioxide in the deep ocean has also been investigated.

Another field of study is that known as mineral carbonation, whereby carbon dioxide is chemically reacted with alkaline and alkaline-earth metal oxide or silicate minerals to form stable solid carbonates. The use of this route in a mineral carbonation process plant using minerals that have been extracted and processed is known as ex-situ mineral carbonation, as opposed to in-situ carbonation, whereby carbon dioxide is deposited into underground mineral formations and reacts over longer timeframes with such minerals in existing underground formations. Ex-situ sequestration via mineral carbonation is described herein.

Mineral carbonation has a number of potential advantages over other methods of carbon dioxide sequestration, including relative permanence and stability and reduced risk of leakage of carbon dioxide gas, thereby eliminating the need for costly long-term monitoring. Furthermore, suitable subterranean sites for geosequestration do not exist at all locations. The chemical reactions of mineral carbonation are also thermodynamically favored, with an exothermic release of energy due to the formation of the carbonates. Many of the minerals used for mineral carbonation are abundant and widely distributed globally. These minerals may be mined and subjected to comminution and other technologies. They are generally benign and the environmental and safety risks are readily manageable. In particular, the mineral broadly known as serpentine (a magnesium silicate hydroxide) has been estimated to be available in quantities sufficient to sequester all global emissions of carbon dioxide from known fossil fuel reserves.

A number of techniques are known for mineral carbonation of carbon dioxide. Thus, in a publication entitled “Activation of magnesium rich minerals as carbonation feedstock materials for CO₂ sequestration,” Fuel Processing Technology 86 (2005) 1627-1645, Maroto-Valer et al. describe the physical and chemical activation of serpentine for reaction with CO₂. Physical activation involves exposing the mineral to steam and air at a temperature of up to 650° C. Chemical activation involves subjecting mineral samples to a suite of acids and bases.

US 2007/0261947 describes a process for the sequestration of carbon dioxide by mineral carbonation in which a magnesium or calcium sheet silicate hydroxide is converted into the corresponding ortho- or chain-silicate by heating using hot synthesis gas at least 600° C. The ortho- or chain-silicate is then contacted with CO₂ to produce magnesium or calcium carbonate and silica.

Notwithstanding these and other methods for sequestration of carbon dioxide by mineral carbonation, it would be desirable to provide alternative and preferably enhanced techniques. Thus, it would be desirable to provide methodology in which the mineral reactant is rendered more highly reactive towards carbon dioxide. This would increase the efficiency of the mineral carbonation process.

### SUMMARY

As described herein, it has been found possible to increase the activity of a particular class of feedstock with respect to mineral carbonation of carbon dioxide by heat treating the mineral in accordance with a particular heat treatment regime.

Accordingly, a method is described for increasing the activity of a hydrous magnesium silicate mineral with respect to mineral carbonation of carbon dioxide, which method comprises thermal shocking of the mineral by very rapid heating.

As described herein, rapid heating (thermal shocking) of a hydrous magnesium silicate mineral results in modifications to the mineral resulting in increased activity with respect to mineral carbonation of carbon dioxide. In this context the increase in activity is relative to the mineral that has not been subjected to such heat treatment. The increase in activity is also relative to the corresponding mineral that has been heated slowly, for example, as described by Maroto-Valer and US 2007/0261947.

Rapid heating of the hydrous magnesium silicate mineral on time scales less than 1 minute, as described herein, is believed to result in structural and compositional changes that result in increased reactivity of the mineral with respect to carbon dioxide. This is in distinct contrast to existing mineral heat activation processes requiring durations in excess of 30 minutes. Without wishing to be bound by theory, these changes are discussed in more detail below.

Also described herein is an activated feedstock for use in the mineral carbonation of CO₂.

Also described is a method for the mineral carbonation of carbon dioxide which includes forming an activated feedstock by thermal shocking of a hydrous magnesium silicate mineral and contacting the activated feedstock with carbon dioxide.

Also described is a method for the mineral carbonation of carbon dioxide which includes forming an activated feedstock by thermal shocking of a hydrous magnesium silicate mineral, forming a suspension or solution including the activated feedstock, and contacting the suspension or solution with carbon dioxide.

In general, various innovative aspects of the subject matter described in this specification feature increasing the activity of a hydrous magnesium silicate mineral with respect to sequestration of carbon dioxide by mineral carbonation by rapid heating of the mineral in combination with one or more of the innovative aspects described below.

In another aspect, treating hydrous magnesium silicate includes heating a quantity of particles of hydrous magnesium silicate with flame conditions to substantially dehydroxylate the particles. The heating includes moving the particles from outside the flame conditions into the flame conditions to subject the particles to an increase in ambient temperature of at least 400° C. in less than (or up to) 10 seconds, heating the particles in the flame conditions for less than (or up to) 10 minutes to an average peak particle temperature to yield a composition, and removing the composition from the flame conditions.

In some implementations, the quantity of particles may be transformed into a composition comprising forsterite or consisting essentially of forsterite. In certain implementations, heating includes moving the particles from outside the flame conditions into the flame conditions to subject the particles to an increase in ambient temperature of at least 400° C. in less than (or up to) 1 second. In certain implementations, the particles are heated in the flame conditions for less than (or up to) 2 minutes to an average peak particle temperature to yield the composition. In some cases, the heating achieves an average peak temperature with respect to the hydrous magnesium silicate of at least 600° C. In some examples, heating occurs in a hydrocarbonaceous fuel-fired furnace, calciner, fluidized bed calciner, or in a plasma or electric arc.

In some implementations, sequestration of carbon dioxide includes forming an activated feedstock by rapid heating of a hydrous magnesium silicate mineral by a method including one of the various aspects and/or implementations, and contacting the activated feedstock with carbon dioxide to form magnesium carbonate. Certain implementations include separating metal oxides other than magnesium oxide and magnesium silicate from the activated feedstock to produce a residual activated feedstock including magnesium oxide and magnesium silicate, and contacting the residual activated feedstock with carbon dioxide to form magnesium carbonate.

The activated feedstock or residual activated feedstock may be cooled for a length of time before contacting with the carbon dioxide. In some cases, the activated feedstock or residual activated feedstock is exposed to humid gaseous carbon dioxide during at least part of the time the activated feedstock or residual activated feedstock is cooling. Certain implementations include combining a solvent and the activated feedstock or residual activated feedstock to form a suspension, solution, or slurry or solution. In an example, the solvent is water, and the suspension, slurry, or solution is aqueous.

The details of one or more embodiments are set forth in the accompanying drawings and the description below. Other features, objects, and advantages will be apparent from the description and drawings, and from the claims.

### BRIEF DESCRIPTION OF DRAWINGS

Embodiments are illustrated with reference to the accompanying non-limiting drawings in which:

FIG. 1 illustrates change in weight of a serpentine mineral with temperature for various heating regimes. (See McKelvy et al., Environ. Sci. Tech. 38, 6897 (2004).)

FIG. 2 shows X-ray diffraction spectra of lizardite feedstock and various dehydroxylation products of lizardite. (See McKelvy et al., Environ. Sci. Tech. 38, 6897 (2004).)

FIG. 3 shows detailed view of an X-ray diffraction spectrum for a mixture of lizardite and a dehydroxylation product of lizardite. (See McKelvy et al., Environ. Sci. Tech. 38, 6897 (2004).)

FIG. 4 illustrates phase fraction of lizardite and dehydroxylation products of lizardite as a function of dehydroxylation. (See McKelvy et al., Environ. Sci. Tech. 38, 6897 (2004).)

FIG. 5 shows a schematic view of an experimental set-up for a dehydroxylation process.

FIG. 6 shows X-ray diffraction spectra for lizardite samples heated at 1000° C. for a range of exposure times.

FIG. 7 illustrates a proposed structure of a dehydroxylation product of lizardite.

FIG. 8 shows an X-ray diffraction spectrum of a dehydroxylation product of lizardite heated for 160 sec at 1000° C. and a calculated spectrum for the structure illustrated in FIG. 7.

FIG. 9 shows SEM images of a dehydroxylation product of lizardite.

FIG. 10 shows SEM images of a dehydroxylation product of lizardite.

FIG. 11 shows SEM images of a dehydroxylation product of lizardite.

FIG. 12 shows SEM images of a dehydroxylation product of lizardite.

FIG. 13 shows X-ray and synchrotron data of unreacted and reacted flash-treated lizardite.

### DETAILED DESCRIPTION

In some cases, a hydrous magnesium silicate mineral (hereafter the “starting mineral”) is heated to render it highly active for reaction with CO₂. Thus, the starting mineral is subjected to rapid heating (herein otherwise termed “thermal shocking”) to produce an activated feedstock. In this context, the increase in activity is relative to that of the starting mineral prior to rapid heating, and also relative to the corresponding mineral if subjected to relatively slow conventional heating. Rapid heating of the starting mineral is believed to cause structural and compositional changes that result in increased activity with respect to sequestration of carbon dioxide.

As used herein, a “hydrous mineral” generally refers to a mineral that includes water (H₂O), hydroxyl groups (—OH), or any combination thereof, in various crystal forms and aggregates. A hydrous mineral can have a water content, a hydroxyl content, or a combined water and hydroxyl content of at least about 5 wt % (expressed as a water/hydroxyl content of at least about 5 wt %). For example, a hydrous mineral can have a water/hydroxyl content between about 5 wt % and about 20 wt %, or about 13 wt %. In some cases, a hydrous mineral has a water/hydroxyl content of at least about 20 wt %.

Rapid heating of the starting mineral is believed to result in structural changes that render the product of heating active with respect to mineral carbonation by reaction with CO₂. Without wishing to be bound by theory, thermal shocking of the starting mineral is believed to result in one or more of the following effects.

Water molecules and/or /hydroxyl groups inherently bound within the structural lattice of the starting mineral are driven off during thermal shocking. In turn, this can lead to an alteration in the crystal structure of the starting mineral and improved dissolution of magnesium ions in water. In other words, the result is increased availability of magnesium ions for reaction (in solution) with carbon dioxide. Reducing the water/hydroxyl content of a hydrous mineral to form an anhydrous mineral in this way may be referred to as dehydrating the hydrous mineral. In some embodiments, dehydrating includes removing water, hydroxyl groups (dehydroxylation), or a combination thereof from a hydrous mineral.

In an example, rapid thermal treatment of the hydroxyl magnesium silicate mineral lizardite (Mg₃Si₂O₅(OH)₄) yields forsterite (Mg₂SiO₄). Forsterite readily reacts with carbon dioxide to form magnesium carbonate:

Mg₂SiO₄+2CO₂→2MgCO₃+SiO₂

Thermal shocking of the starting mineral may also lead to an increase in surface area, thereby rendering magnesium present in the crystal lattice more available for reaction with CO₂.

The mineral that is heated is a hydroxyl magnesium silicate mineral. The CO₂-reactivity of a variety of hydrous and hydroxyl magnesium silicate minerals, including their polymorphs, may be increased by rapid heading. The starting mineral may be magnesium-rich, with the molar ratio of magnesium to silicon of at least 3:2. The starting mineral may be serpentine, talc, olivine, or mixtures thereof.

Serpentine minerals include rock-forming hydrous/hydroxyl magnesium iron phyllosilicates, which can include chromium, manganese, cobalt, nickel, or any combination thereof. Serpentine minerals have the general formula (Mg, Fe)₃ Si₂O₅(OH)₄. The various minerals may be found mixed together in various ratios. In some cases, one of the two silicon atoms may be replaced by an aluminum atom or an iron atom. Polymorphs of serpentine include antigorite, chrysotile, and lizardite. Lizardite, or orthoantigorite, is a fine-grained, scaly mineral with the formula Mg₃Si₂O₅(OH)₄.

Rapid heating of serpentine can result in formation of a meta-serpentine mineral with a reduced hydroxyl content according to the reaction:

Mg₃Si₂O₅(OH)₄→Mg₃Si₂O₍₅₊₂ₓ₎(OH)₍₄₋₄ₓ₎+2x(H₂O),

where x represents the degree of dehydroxylation, and 0≦x≦1.

By way of further example, the hydrous mineral lizardite (a meta-serpentine mineral derived from serpentine), can be heated to form the anhydrous minerals forsterite (Mg₂SiO₄) and enstatite (MgSiO₃) according to the reaction:

Mg₃Si₂O₅(OH)₄→Mg₂SiO₄+MgSiO₃+2H₂O.

Rapid heat treatment can involve heating the starting mineral from an average initial temperature to an average final temperature to convert a majority (at least 50 wt %, or at least 75 wt %) of the hydrous starting mineral to an anhydrous form. The average initial temperature can be room or ambient temperature or higher. The average final temperature may be, for example, at least about 600° C., at least about 700° C., at least about 800° C., at least about 900° C., or at least about 1000° C. In some cases, a maximum average final temperature may be about 1100° C.

In some embodiments, the change in temperature from the average initial to average final temperature takes place rapidly. Herein the rate at which the temperature change is achieved is termed the “average instantaneous heating rate,” which refers to the difference between the average final temperature and the average initial temperature divided by the time taken for the temperature change to take place. In some cases, the average instantaneous heating rate is at least about 1000° C./sec, at least about 5000° C./sec, or at least about 10,000° C./sec. The rate of heating may depend upon, for example, the form in which the serpentine mineral is provided, the method of heating, the apparatus used, or any combination thereof.

Rapid heat treatment can be achieved in a variety of ways. The starting mineral can be heated directly using a flame. In this case, the requisite instantaneous heating rate may be achieved by providing the starting mineral within the flame or region thereof. It may also be possible to achieve a suitable instantaneous heating rate by providing the starting mineral closely adjacent to, but not actually within, the flame. Such conditions are termed “flame conditions.” The flame conditions may vary between fuels that are used to generate the flame, the combustion conditions, and the spatial region of the flame. Flame conditions of common fuels that may be suitable for this purpose can range between 600° C. and 2000° C., based on factors including, for example, the fuel, combustion settings, burner design, and the spatial region of the flame. Fuels that may be suitable for this purpose include common fuel gases, such as natural gas, methane, ethane, propane and butane; solid fuels such as pulverized coal; or liquid hydrocarbon fuels such as furnace oil.

It may also be possible to achieve a suitably high rate of heating using a plasma or electrical arc. These heating methods may provide improved control of heating rates. For large scale implementation, a method of heating may be selected to allow large throughputs, flash heating, reduced particle sintering, or any combination thereof. The method may meet the exemplary process conditions for the carbonation of emissions from a power plant shown below.

| Ore Flow Rate | 1000-5000 tonnes/h |
|---|---|
| Ore Inlet Temperature | 298-600 K |
| Activation Temperature | 900-1300 K |
| Heating Rates | Very high (>100 K/s) |
| Dehydroxylation Enthalpy | 473 MJ/t |
| Overall Energy Requirement | 450-2500 MW |
| Ore Conversion | >95% |

Furnaces or calciners may be designed to achieve the desired average instantaneous heating rates and average heating rates as well as the desired final average temperatures as specified herein. Calciners, such as gas-fired fluidized bed calciners, may be suitable. Once the average final temperature is achieved, that average final temperature may be maintained for a length of time to ensure that the desired compositional and structural transformations are achieved. The overall heat treatment employed may be characterized by taking this into account. Thus, herein the term “average heating rate” is used to denote the difference between the average final temperature and the average initial temperature divided by the overall duration of heating. In an example, if a quantity of a hydrous mineral is rapidly heated from 25° C. to 1000° C., and then maintained at 1000° C. for a total heating duration of 10 seconds (during which time a majority of the starting mineral is converted to an anhydrous mineral), the average heating rate would be 97.5° C./sec.

In some cases, the average instantaneous heating rate and average heating rate may be the same or substantially the same. In some cases, the average instantaneous heating rate may be greater than the average heating rate. In one example, if the quantity of hydrous starting mineral is heated from an average initial temperature of 25° C. to an average final temperature of 1000° C. in 0.1 sec, and is then maintained at 1000° C. for a total heating duration of 10 sec, the instantaneous heating rate would be about 9750° C./sec, whereas the average heating rate would be about 97.5° C./sec. In another example, if a quantity of hydrous mineral is heated from 25° C. to 1000° C. in 0.05 sec and then maintained at 1000° C. for a total heating duration of 10 sec, the instantaneous heating rate would be about 19500° C./sec and the average heating rate would be about 97.5° C./sec. In some cases, to achieve the desired mineral transformations, a relatively low average instantaneous heating rate may be combined with a relatively high final temperature, or vice versa.

The overall length of time to convert a majority of hydrous starting mineral to the anhydrous form may vary depending upon, for example, particle size, initial temperature, final temperature, average heating rate, average instantaneous heating rate, water/hydroxyl content of the hydrous mineral, and the like. For an average instantaneous heating rate of at least about 5000° C./sec, the length of time to convert a majority of hydrous starting mineral to anhydrous form can be less than about 10 min, less than about 5 min, less than about 4 min, less than about 3 min, less than about 2 min, or less than about 1 min. In some cases, the length of time required to convert a majority of the hydrous mineral to anhydrous form may be less. For instance, with a high average instantaneous heating rate (e.g., greater than 5000° C./sec), the time may be less than about 30 sec, less than about 20 sec, or less than about 10 sec. When the average instantaneous heating rate is high, for example greater than 10,000° C./sec, the time may be less than about 0.5 sec, less than about 0.25 sec, or less than about 0.1 sec.

The starting mineral to be heated may be in particulate form. Grinding or communition may be used to achieve a starting mineral feedstock suitable for use. An average particle size distribution may be centered at about 38 μm, about 75 μm, about 150 μm, or about 200 μm. In some cases, the average particle size is less than about 500 μm, less than about 200 μm, or less than about 100 μm. In certain cases, the average particle size can be in a range between about 10 μm and about 100 μm, between about 100 μm and about 200 μm, or between about 200 μm and about 500 μm.

Activated feedstock formed by thermal shocking of a hydrous magnesium silicate mineral as described herein may be contacted with carbon dioxide. A method for the sequestration of carbon dioxide includes forming an activated feedstock by rapid heating of a hydrous magnesium silicate mineral, forming a suspension or solution including the activated feedstock, and contacting the suspension or solution with carbon dioxide. It has been found that thermally shocked (flash treated) mineral samples react with carbon dioxide at T=130° C. and P_{CO2}=2300 psi, below the standard carbonation aqueous conditions (T=185° C., P_{CO2}=2300 psi) (see O'Connor et al. Carbon dioxide sequestration by direct mineral carbonation: process mineralogy of feed and products Minerals & Metallurgical Processing 19:95-101 (2002)). Thus, flash treatment (e.g., heating with average instantaneous heating rates of at least about 100° C./sec) represents a mineral pre-treatment option for CO₂ mineral sequestration. In some embodiments, thermal shocking of the starting mineral may be performed in a carbon dioxide atmosphere (e.g., a humid CO₂+H₂O gas environment) to promote nucleation of carbonates in subsequent carbon dioxide carbonation reactions.

The reactivity of an activated feedstock may be assessed based on attenuation total reflection (ATR) infrared spectroscopy. This method may eliminate the need for time-consuming batch autoclave studies, or expensive in-situ synchrotron studies for multiple samples.

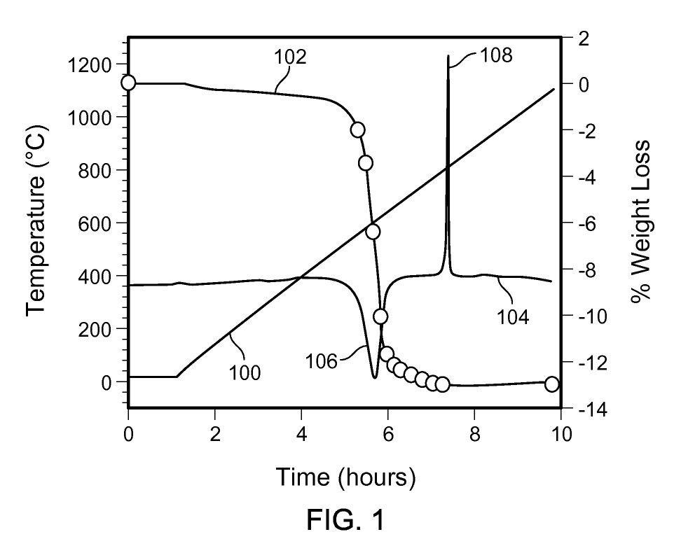

FIG. 1 (data from McKelvy et al., Environ. Sci. Tech. 38, 6897 (2004)) shows change in temperature and weight of a serpentine mineral during a slow roasting (dehydroxylation) process. Plot 100 indicates heating of the sample at a rate of about 2° C./min. Plot 102 indicates weight loss of the sample during the initial stages of heating, with the small step near the onset due to desorption of water. Weight loss of 13 wt % represents complete dehydroxylation (via evolution of H₂O) of the serpentine mineral to form an anhydrous mineral. Intermediate weight loss (i.e., between 0 wt % and 13 wt %) is indicative of the presence of meta-serpentine minerals. Dehydroxylation begins at 350° C., as evidenced by the onset of the primary weight loss step and the associated endotherm 106 seen in plot 104. At higher temperatures, when dehydroxylation is nearly complete, the rate slows, with the loss of residual hydroxyl groups continuing until the strong exotherm 108 at 782° C., which indicates the condensation of an amalgam comprised of equal amounts of forsterite (Mg₂SiO₄) and enstatite (MgSiO₃).

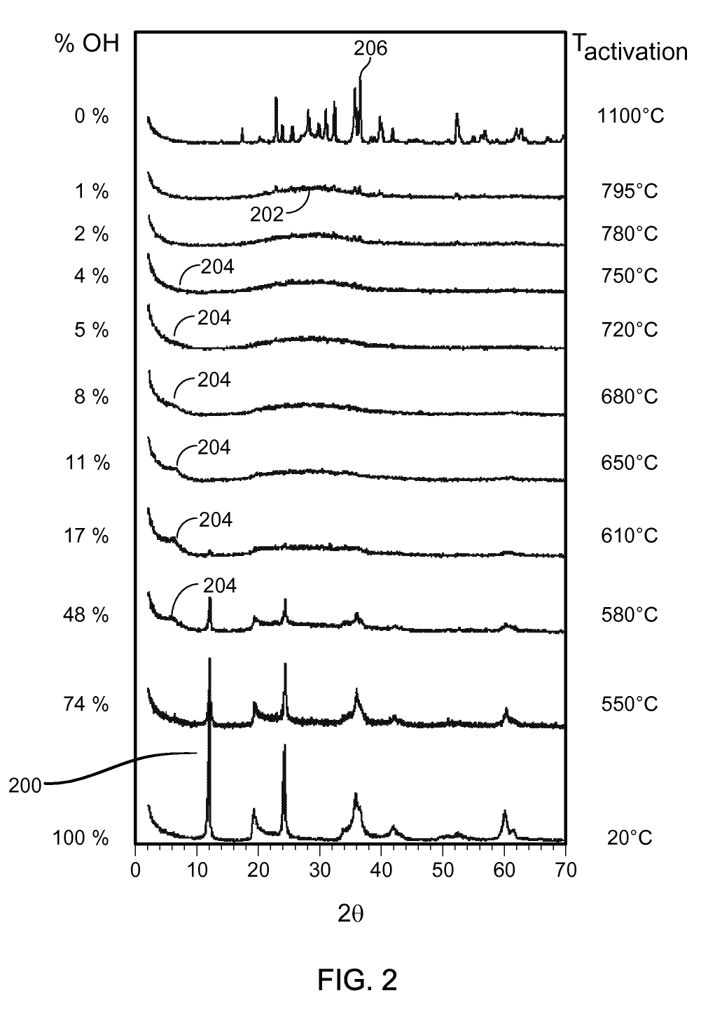

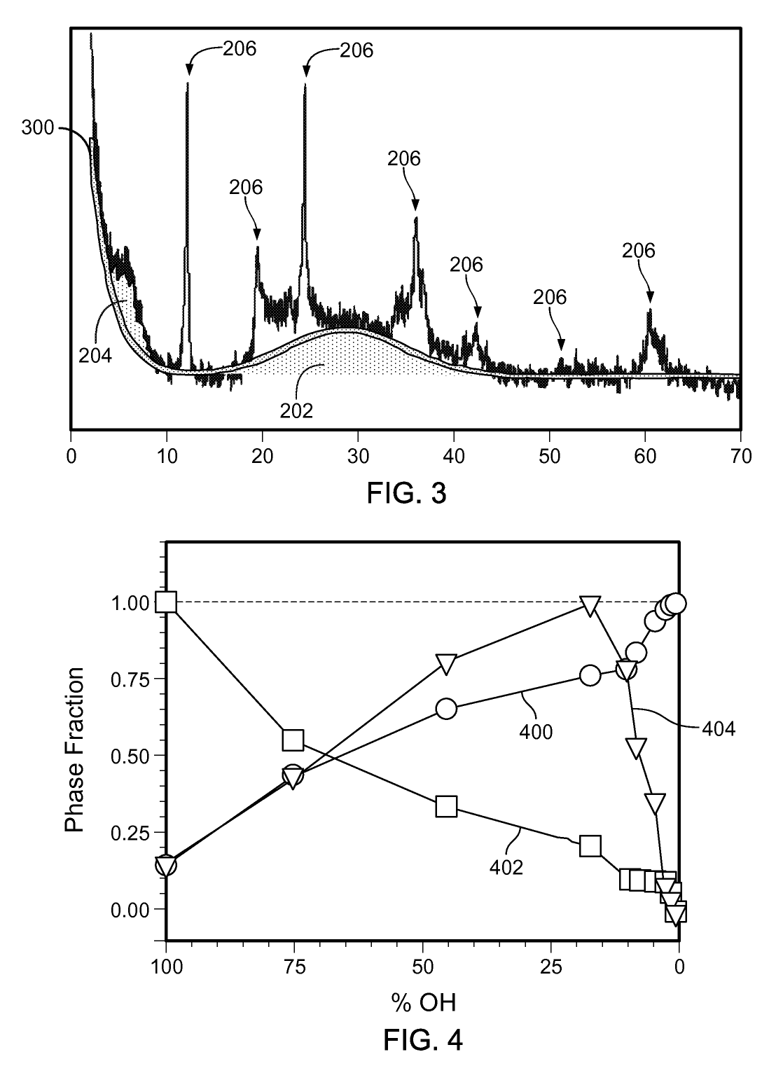

FIG. 2 (data from McKelvy et al., Environ. Sci. Tech. 38, 6897 (2004)) shows X-ray diffraction spectra as a function of weight percentage of hydroxyl removed during heating of lizardite feedstock (Mg₃Si₂O₅(OH)₄). Meta-lizardite samples were produced by heating at 2° C./min in the range from 20° C. to 1100° C. and then rapidly cooling to isolate the desired materials at each temperature, denoted by T_{activation}. The TGA/DTA analyses were carried out under helium using a Setaram TG92 thermal analysis system (Setaram Instrumentation, Caluire, France). Residual hydroxide compositions for the meta-serpentine materials produced were determined by weight loss. X-ray powder diffraction patterns were obtained for each of the resulting materials using a Rigaku D/MAX-IIB X-ray diffractometer with Cu KR radiation (Rigaku Americas Corporation, The Woodlands, Tex.). Thus, for T_{activation} of 20° C., no hydroxyl groups are removed from the lizardite feedstock (100 wt % of the hydroxyl groups remain) and the X-ray diffraction spectrum is characteristic of lizardite. For T_{activation} of 1100° C., 100 wt % of the lizardite hydroxyl groups are removed to form an anhydrous mineral. For T_{activation} of 550° C. to 795° C., corresponding to 74 wt % to 1 wt % of hydroxyl groups remaining, respectively, the X-ray diffraction pattern shows a decreasing presence of features 200 due to lizardite, and an increasing presence of a broad feature 202 due to an “amorphous” phase between 2θ of 15 to 40 is seen in FIG. 3. An additional feature 204, designated as the serpentine α-phase, increases from T_{activation} of 20° C. to over 600° C., and then begins to decrease. Crystalline features 206 are seen for the sample with T_{activation} of 1100° C. For T_{activation} of 610° C. to 750° C., strong CO₂ reactivity is exhibited by the various meta-lizardite samples as inferred by their reaction in standard aqueous solution (1M NaCl+0.64M NaHCO₃) at P_{CO2}˜2300 psi at temperatures ranging from 100° C. to 125° C. As seen in FIG. 2, these samples contain 4-17% residual hydroxide. A moderately reactive sample is formed at T_{activation} of 580° C., (reaction temperature 120° C.), and a non-reactive sample is formed at T_{activation} of 20° C. (reaction temperature 120° C.).

FIG. 3 (data from McKelvy et al., Environ. Sci. Tech. 38, 6897 (2004)) shows the superposition of the crystalline features 206 on top of the amorphous phase feature 202, along with the presence of the α-phase 204 in greater detail. Air scattering 300 is also seen in FIG. 3. FIG. 4 (data from McKelvy et al., Environ. Sci. Tech. 38, 6897 (2004)) illustrates phase fraction of lizardite, various meta-serpentines, and anhydrous mineral shown in FIG. 2 as a function of residual hydroxyl content (e.g., % OH). Plot 400 shows an increase in the amorphous phase with dehydroxylation. Plot 402 shows a decrease in crystalline lizardite content with dehydroxylation. Plot 404 shows the increase and subsequent decrease in the α-phase as dehydroxylation progresses. Collectively, the data in FIG. 2 and FIG. 4 indicate that the degree of reactivity of the “roasted” lizardite is correlated with the amount of α-phase evolved during dehydroxylation.

In some embodiments, metal oxides other than magnesium oxide and magnesium silicate (considered herein to be a metal oxide) are separated from the activated feedstock prior to reaction with carbon dioxide. The separation of metal oxides, other than magnesium oxide and magnesium silicate, may be performed after activation to produce a residual activated feedstock stream richer in magnesium oxide and magnesium silicate and with reduced quantities of other metal oxides prior to reaction with carbon dioxide. Such removal of other metal oxides substantially reduces the downstream process requirements. Metal oxides that can be removed in this process include oxides of one or more of iron, silicon, aluminum, manganese, chromium, nickel, titanium, copper, potassium, phosphorus, calcium and sodium. Oxides that are of low commercial value such as those of silicon and aluminum, or oxides that are present in insufficient quantities to be of commercial value, such as those of potassium, phosphorous, and sodium, may be withdrawn from the process for waste disposal. Those metal oxides of sufficient commercial value contained in the feedstock may also be recovered from the separated stream after rapid thermal activation. Such minerals may include the oxides of iron chromium, nickel, and manganese.

Thus, the separation of silica and other metal oxides after thermal activation reduces the downstream process requirements and costs while the recovery of the valuable metal oxides provides a revenue stream. The overall process is thus rendered more economically competitive with other forms of carbon dioxide sequestration.

The separation of metal oxides at least substantially excluding magnesium oxide and magnesium silicate after rapid thermal activation may be achieved by various separation means, such as density or gravity separation, centrifugal separation, flotation, filtration, magnetic separation, electrostatic separation, or any combination thereof. Other density separation technologies include processes using spirals, hindered settling vessels, cyclones, hydrocyclones, and any combination thereof. Combinations of density separation and magnetic separation may be beneficial, for example, for recovering and concentrating iron ore in particular.

It will be understood by those skilled in the art that such separation processes have associated separation efficiencies, thus invariably resulting in imperfect separation and thus carry-over of some portion of the components to be separated into the other, separated, stream. For example, a proportion of the metal oxides to be separated from the residual activated feedstock stream will invariably be carried over into said residual activated feedstock stream and vice versa. A certain proportion of magnesium oxide and/or magnesium silicate may thus also be lost into the separated metal oxide streams. However, the aim is to substantially retain the largest proportion of the magnesium oxide and magnesium silicate in the residual activated feedstock stream. Hence metal oxides, at least substantially excluding magnesium oxide and magnesium silicate, are separated from the residual activated feedstock after rapid thermal activation. As used herein, “at least substantially excluding magnesium oxide and magnesium silicate” refers to excluding at least 50% of the total magnesium oxide and magnesium silicate originally present in the activated feedstock after rapid thermal activation. Thus, at least 50% of the magnesium oxide and magnesium silicate is retained in the residual activated feedstock stream. In some cases, a higher proportion of the magnesium oxide and magnesium silicate is retained in said residual activated feedstock stream (e.g., at least 75 wt %).

The use of density separation may allow metal oxides of lower economic value to be separated into a low density stream while also separating the metal oxides of higher economic value into a high density stream. The residual activated feedstock stream containing most of the originally present magnesium oxide and magnesium silicate forms a stream of intermediate density for the subsequent process of conversion into magnesium carbonate.

The residual activated feedstock may be subsequently contacted with carbon dioxide to form magnesium carbonate. In some cases, the residual activated feedstock is contacted with supercritical, liquefied, or high-pressure gaseous carbon dioxide to form magnesium carbonate by reacting substantially all of the carbon dioxide with excess feedstock. The term “high-pressure,” as used herein, refers to pressures in excess of 5 bar (e.g., in excess of 50 bar).

The following non-limiting examples are provided for illustration.

### Example 1

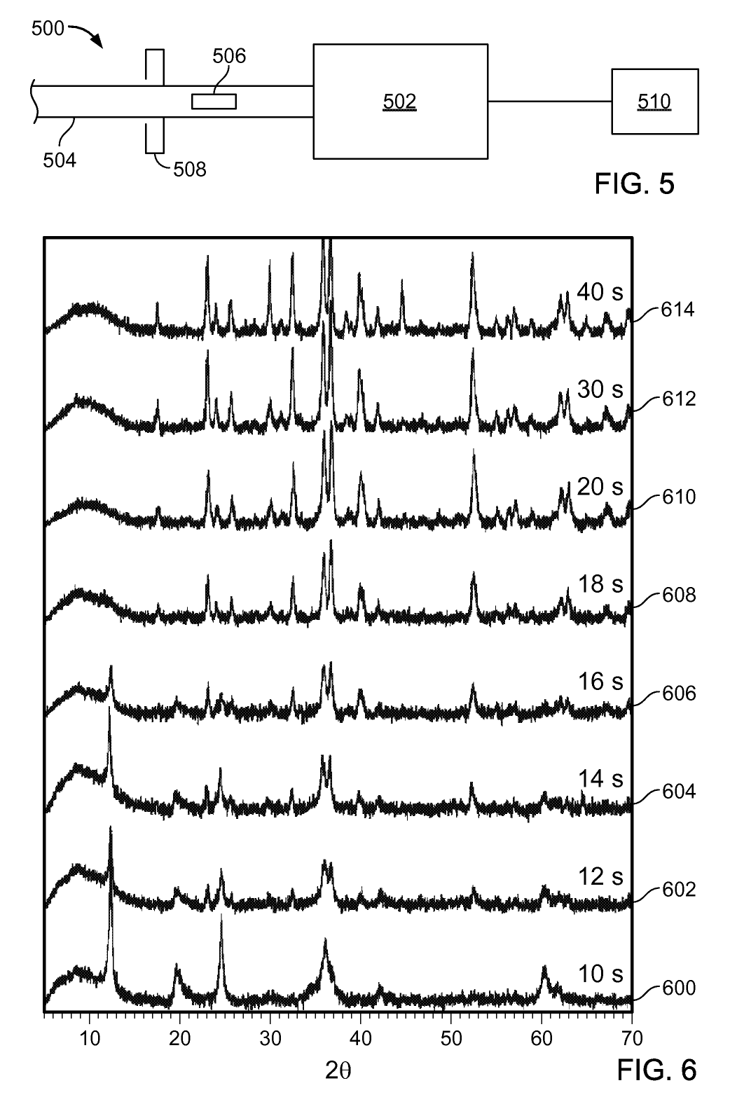

FIG. 5 shows a schematic view of an experimental apparatus 500 used to subject lizardite samples to rapid thermal treatment. Twenty lizardite samples with an average particle size of 38 μm were subjected to rapid thermal treatment at high temperature in a controlled single-zone high-temperature tube furnace 502 (Lindberg Model HTF55122A; Lindberg/MPH, Riverside, Mich.) to yield “flash” treated meta-lizardite. The samples were introduced through tube 504 into the furnace in platinum sample boats 506. A magnetic yoke 508 was used to insert and extract sample materials from the hot zone, which was held at a temperature between 1000° C. and 1100° C. Gas flow control and bubbler 510 were coupled to the tube furnace 502. The samples were inserted rapidly (e.g., 0.3 sec to 0.5 sec) to provide average instantaneous heating rates (dT/dt) between 2000° C./sec and ˜3,300° C./sec, and then held at the internal tube furnace temperature for various times in the range 1-160 seconds.

Exposure time of the samples were as shown below:

Series A: 1 sec, 2 sec, 3 sec, 5 sec, 10 sec, 20 sec, 30 sec

Series B: 40 sec, 80 sec, 160 sec

Series C: 10 sec, 12 sec, 14 sec, 16 sec, 18 sec, 20 sec

Series D: 10 sec, 11 sec, 12 sec, 13 sec

After heat treatment, powder X-ray diffraction studies were performed on the samples on a SIEMENS XRD (SIEMENS USA) spectrometer, with a scan time of about 2 hours per sample.

FIG. 6 shows X-ray diffraction spectra 600, 602, 604, 606, 608, 610, 612, and 614 for the samples with exposure times of 10 sec, 12 sec, 14 sec, 16 sec, 18 sec, 20 sec, 30 sec, and 40 sec, respectively. Plot 600, showing data from the sample with an exposure time of 10 sec, is characteristic of lizardite. Plot 614, showing data from the sample with an exposure time of 40 sec, is characteristic of forsterite. Thus, dehydroxylation of lizardite to form an anhydrous mineral is shown to occur in less than one minute with a final or peak temperature of at least 1000° C.

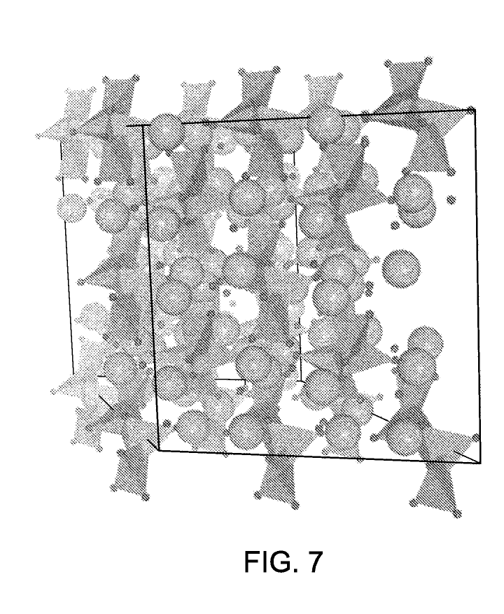

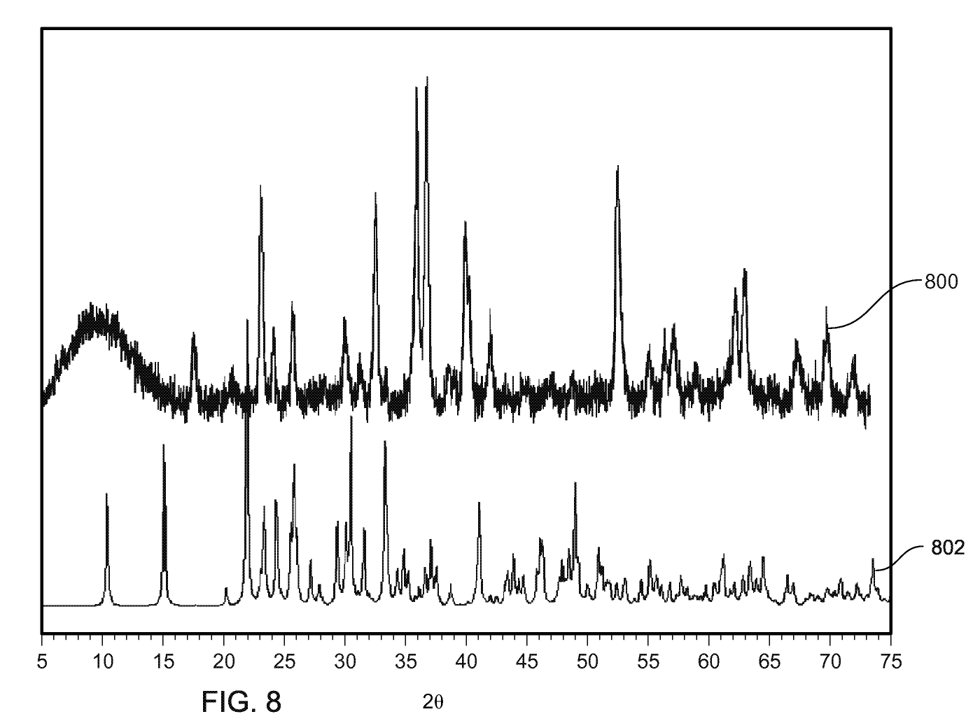

The rapid thermal treatment of samples with an exposure time of at least 40 sec did not indicate formation of enstatite. The non-forsteritic product is thought to be an amorphous phase, or a “metastable” rankinite (Ca₃Si₂O₇) analog with a chemical formula of Mg₃Si₂O₇, as shown in FIG. 7. Plot 800 in FIG. 8 shows the X-ray diffraction spectrum of the sample exposed to 1000° C. for 160 sec. Plot 802 is a calculated spectrum for the proposed rankinite analog phase based on an equilibrium structure obtained from density functional theory (DFT) simulations, indicating the possible origin of non-forsteritic features.

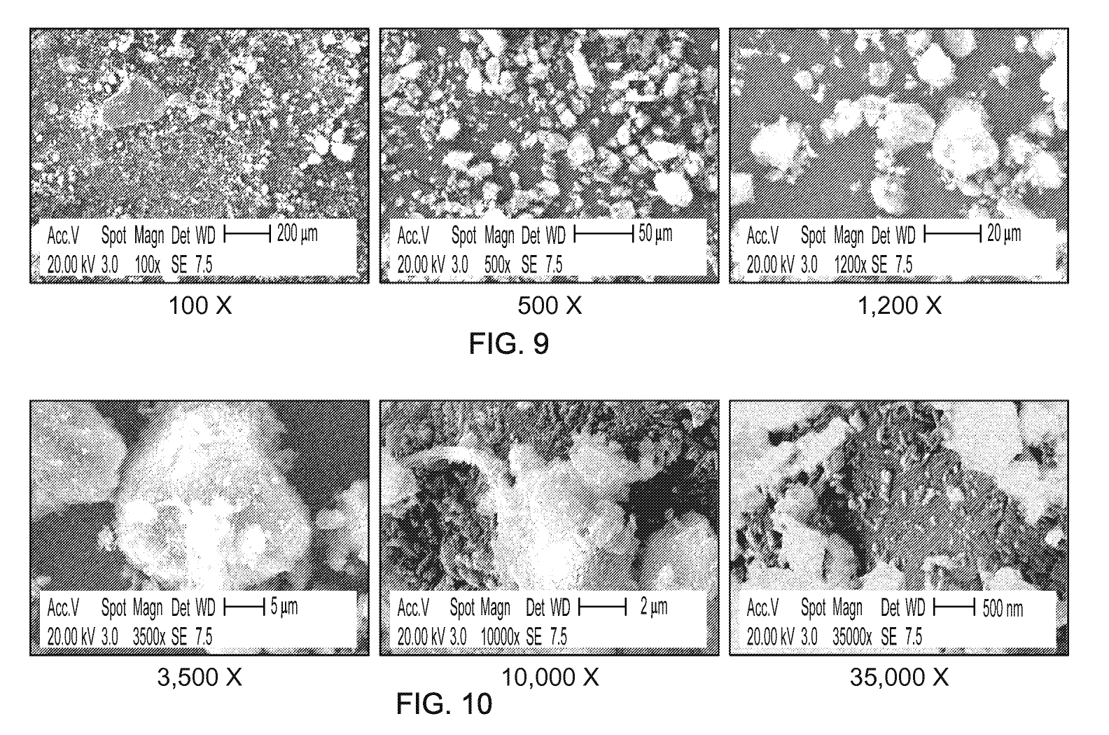

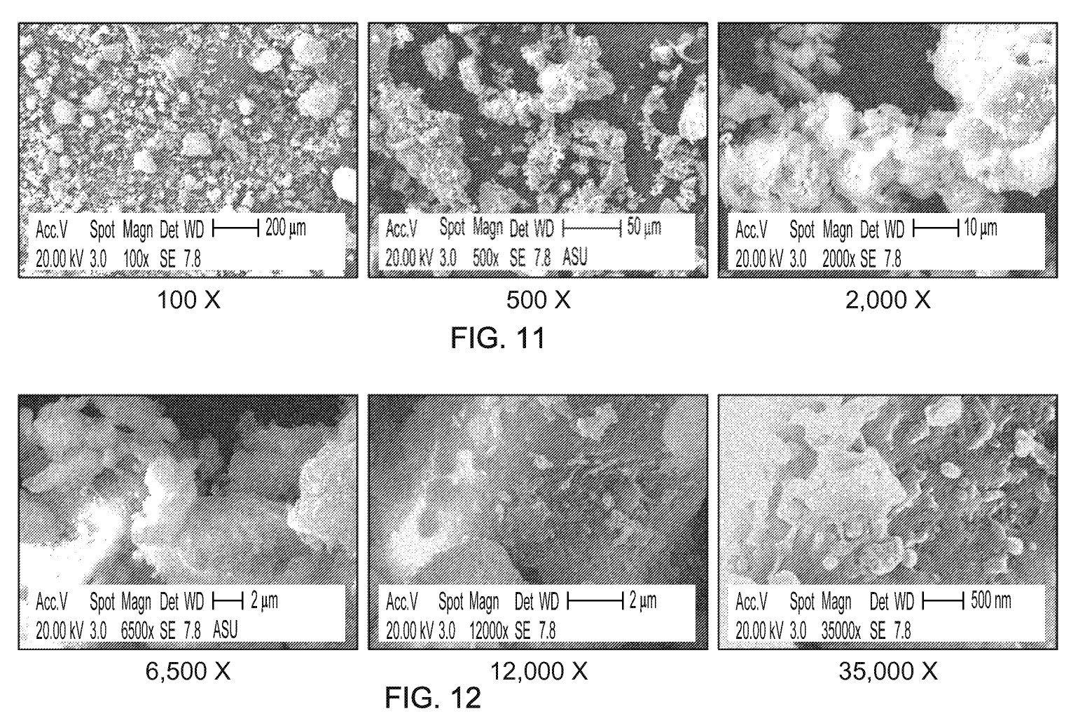

SEM characterization of flash-treated meta-lizardite samples was performed with a FEI SL30 high resolution environmental scanning electron microscope (FEI Company, Hillsboro Oreg.), capable of routine scanning to the sub-micron scale for non-conductive materials. The SEM images indicate agglomeration of particles subjected to prolonged exposure (e.g., 40 sec) at high temperature (1000° C.). Examples of the SEM images are shown in FIGS. 9-12. FIG. 9 shows SEM images at 100×, 500×, and 1,200× of the sample with an exposure time of 12 sec. FIG. 10 shows SEM images at 3,500×, 10,000×, and 35,000× of the sample with an exposure time of 12 sec. FIG. 11 shows SEM images at 100×, 500×, and 2,000× of the sample with an exposure time of 40 sec. FIG. 12 shows SEM images at 6,500×, 12,000×, and 35,000× of the sample with an exposure time of 40 sec. FIG. 12 also indicates the presence of morphological features at the sub-micron scale possibly associated with the evolution and flow of water during dehydroxylation.

### Example 2

Lizardite mineral was ground to an average particle size of 38 μm, yielding a greyish/green product with the consistency of baking flour. The lizardite particles were flash treated to 1000° C. for 12 sec at an average instantaneous heating rate of about 5000° C./sec in a radial furnace to yield a brownish anhydrous powder, as confirmed by thermogravimetric analysis. X-ray analysis of the treated samples indicated that the rapid dehydration transformed the mineral lattice from that of lizardite (Mg₃Si₂O₅(OH)₄) to olivine (Mg₂SiO₄).

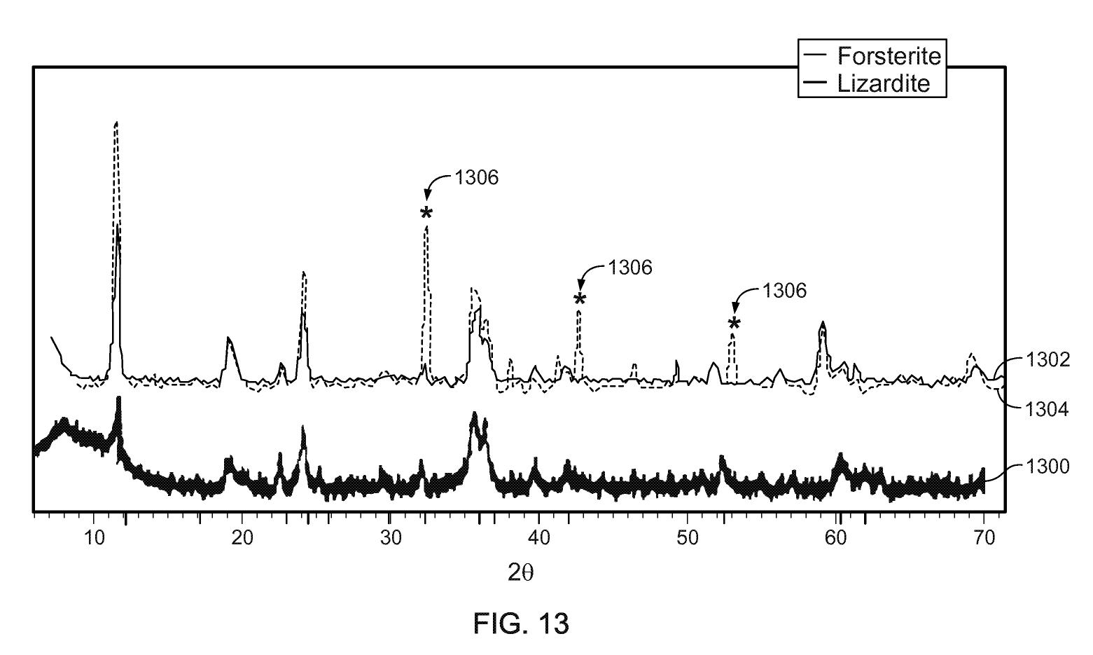

FIG. 13 shows low resolution X-ray data and high resolution synchrotron data from the unreacted and reacted flash-treated lizardite prepared as described in EXAMPLE 2. Plot 1300 shows low resolution X-ray data from the unreacted, flash-treated lizardite. Plot 1302 (solid line) shows high resolution X-ray data from the unreacted, flash-treated lizardite. Plot 1304 (dotted line) shows high resolution X-ray data from the flash-treated lizardite in a “standard” aqueous solution of supercritical CO₂ (P_{CO2}=2300 psi) and high temperature (T=100° C.) taken by a synchrotron minutes after establishing the reaction conditions. Peaks 1306 show the presence of MgCO₃ resulting from the sequestration of CO₂ by the flash-treated lizardite (e.g., olivine), indicating that carbonation (i.e., the conversion of CO₂ into a solid mineral carbonate) has occurred.

A number of embodiments have been described. Nevertheless, it will be understood that various modifications, enhancements and other embodiments may be made based on what is described and illustrated in this disclosure.

1. A method for increasing the activity of a hydrous magnesium silicate with respect to sequestration of carbon dioxide by mineral carbonation, the method comprising rapid heating of the hydrous magnesium silicate.

2. The method of claim 1, wherein rapid heating of the hydrous magnesium silicate comprises heating a quantity of particles of hydrous magnesium silicate with flame conditions to substantially dehydroxylate the particles.

3. The method of claim 2, wherein heating the quantity of particles of hydrous magnesium silicate comprises:
moving the quantity of particles from outside the flame conditions into the flame conditions to subject the particles to an increase in ambient temperature of at least 400° C. in less than 10 seconds;
heating the particles in the flame conditions for less than 10 minutes to an average peak particle temperature to yield a composition; and
removing the composition from the flame conditions.

4. The method of claim 3, wherein the particles are subjected to an increase in ambient temperature of at least 400° C. in less than 1 second, and the particles are heated in the flame conditions for less than 2 minutes to an average peak particle temperature to yield the composition.

5. The method of claim 1, wherein the rapid heating achieves an average peak temperature with respect to the hydrous magnesium silicate of at least 600° C.

6. The method of claim 1, wherein the rapid heating occurs in a hydrocarbonaceous fuel-fired furnace, calciner, fluidized bed calciner, or in a plasma or electric arc.

7. The method of claim 3, wherein the composition comprises forsterite.

8. A method for the sequestration of carbon dioxide, the method comprising:
forming an activated feedstock by rapid heating of a hydrous magnesium silicate; and
contacting the activated feedstock with carbon dioxide to form magnesium carbonate.

9. The method of claim 8, wherein the rapid heating of the hydrous magnesium silicate comprises heating a quantity of particles of hydrous magnesium silicate with flame conditions to substantially dehydroxylate the particles.

10. The method of claim 9, wherein heating the quantity of particles of hydrous magnesium silicate with flame conditions comprises:
moving the quantity of particles from outside the flame conditions into the flame conditions to subject the particles to an increase in ambient temperature of at least 400° C. in less than 10 seconds;
heating the particles in the flame conditions for less than 10 minutes to an average peak particle temperature to yield the activated feedstock; and
removing the activated feedstock from the flame conditions.

11. The method of claim 10, wherein the particles are subjected to an increase in ambient temperature of at least 400° C. in less than 1 second, and the particles are heated in the flame conditions for less than 2 minutes to an average peak particle temperature to yield the activated feedstock.

12. The method of claim 8, wherein the rapid heating achieves an average peak temperature with respect to the hydrous magnesium silicate of at least 600° C.

13. The method of claim 8, wherein the rapid heating occurs in a hydrocarbonaceous fuel-fired furnace, calciner, fluidized bed calciner, or in a plasma or electric arc.

14. The method of claim 8, wherein the activated feedstock comprises forsterite.

15. The method of claim 8, further comprising cooling the activated feedstock for a length of time before contacting the activated feedstock with the carbon dioxide.

16. The method of claim 15, further comprising exposing the activated feedstock to humid gaseous carbon dioxide during at least part of the time the activated feedstock is cooling.

17. The method of claim 8, further comprising combining a solvent and the activated feedstock to form a suspension, slurry, or solution.

18. The method of claim 17, wherein the solvent is water, and the suspension, slurry, or solution is aqueous.

19. The method of claim 8, further comprising
separating metal oxides other than magnesium oxide and magnesium silicate from the activated feedstock to form a residual activated feedstock richer in magnesium oxide and magnesium silicate than the activated feedstock;
cooling the residual activated feedstock for a length of time; and
contacting the residual activated feedstock with carbon dioxide to form magnesium carbonate.

20. The method of claim 19, further comprising exposing the residual activated feedstock to humid gaseous carbon dioxide during at least part of the time the residual activated feedstock is cooling.

21. The method of claim 19, further comprising combining a solvent and the activated feedstock or residual activated feedstock to form a suspension, slurry, or solution.

22. The method of claim 21, wherein the solvent is water, and the suspension, slurry, or solution is aqueous.
